(19) United States
(12) Patent Application Publication
(10) Pub. No.: US 2013/0218640 A1
(43) Pub. Date: Aug. 22, 2013

(54) SYSTEM AND METHOD FOR MANAGING ADVERTISING INTELLIGENCE AND CUSTOMER RELATIONS MANAGEMENT DATA

(71) Applicants: David S. Kidder, Mamaroneck, NY (US); Nidhi Khator, Delhi (IN); Jordan Franklin, New York, NY (US)

(72) Inventors: David S. Kidder, Mamaroneck, NY (US); Nidhi Khator, Delhi (IN); Jordan Franklin, New York, NY (US)

(21) Appl. No.: 13/735,479

(22) Filed: Jan. 7, 2013

Related U.S. Application Data
(60) Provisional application No. 61/583,757, filed on Jan. 6, 2012.

(51) Int. Cl. G06Q 30/02

(52) U.S. Cl. CPC G06Q 30/0204
USPC 705/7.33

(57) ABSTRACT

Provided are systems and methods for managing an entity's social graph including integration between advertising network management, social customer relationship management (CRM), and social media management. The system can include a social engagement engine for analyzing data from both CRM systems and advertising monitoring and management systems. The social engagement engine can be configured to segment the received data and discover insights into the social graph describing the entity's contacts. Insights developed from advertising, CRM data, and third party data can then be used to optimize advertising strategies. In some examples, the insights into an entity's connections can be used to optimize CRM strategies. CRM strategies can be employed to strengthen ties to existing customers, identify valuable customers, and recapture lost customers by delivering offers and/or opportunities to customers.

### RELATED APPLICATIONS

This application claims priority under 35 U.S.C. §119(e) to U.S. Provisional Application No. 61/583,757, entitled “SYSTEM AND METHOD FOR MANAGING ADVERTISING INTELLIGENCE AND CUSTOMER RELATIONS MANAGEMENT DATA,” filed on Jan. 6, 2012, which application is hereby incorporated herein by reference in its entirety.

### BACKGROUND

Various conventional approaches exist to manage delivery of advertising content to customers. These advertising systems can include, for example, the known YAHOO! ADWORDS platform. Some other conventional systems can provide for management of customer information, and for management of customer interaction between a supplier and existing customers. These system can include, for example, the known CONSTANT CONTACT platform.

### SUMMARY

In broad overview, various aspects relate to the development and management of connections for an entity. Every entity, and in particular, a corporate entity is associated with a multitude of contacts. Identifying, defining, and managing those contacts and the connections that bridge an entity and their contacts provides unique opportunities for establishing an entity's social graph. In some embodiments, the social graph defines all the connections between a provider (e.g., a company) and the provider's customers. Development of an entity's social graph enables insight into reaching and influencing both the contacts and the connections to those contacts. In one aspect, a system for managing an entity's social graph provides for integration between advertising network management, social customer relationship management (CRM), and social media management.

The system can include a social engagement engine for analyzing data from both CRM systems and advertising monitoring and management systems. The social engagement engine can be configured to segment the received data and discover insights into the social graph describing the entity's contacts. Insights developed from advertising, CRM data, and third party data can then be used to optimize advertising strategies. In some examples, the insights into an entity's connections can be used to optimize CRM strategies. CRM strategies can be employed to strengthen ties to existing customers, identify valuable customers, and recapture lost customers by delivering offers and/or opportunities to customers.

In some embodiments, optimal target audiences can be identified for delivery of opportunities, and in addition, optimal communication channels can also be identified. An example system can be configured to generate and be responsive to triggering events based on insights into advertising, CRM data, and third party data. Triggering events can be identified from the integration of CRM data and advertising data. Triggering events can identify scenarios and/or situations in which an action can be taken to achieve a customer based objective (e.g., customer retention, customer support, strengthen customer relationship, etc.). Criteria for a triggering event can be defined on a system for managing an entity's social graph. The system can also include criteria for automatically determining an action for a given scenario based on, for example, the context of the scenario and/or available data on the affected customer.

According to one aspect, a system for managing an entity's social graph. The system comprises at least one processor operatively connected to a memory, the processor configured to execute a plurality of system components, the plurality of system components comprising an integration component configured to accept customer data from a plurality of data sources, the data sources including at least one of: at least one CRM platform and at least one aggregation platform, accept social media information from at least one social platform, a segmentation engine configured to segment a customer population into a plurality of segments, based, at least in part on the customer data and social media information, an insight engine configured to generate an insight for at least one of the plurality of segments, and a generation engine configured to generate an action responsive to the insight.

According to one embodiment, the generation engine is configured to communicate the action to the at least one CRM platform, wherein the action is configured to cause the CRM system to deliver an offer to a customer based on the action. According to one embodiment, the system further comprises a tracking component configured to track redemption of the offer. According to one embodiment, tracking the redemption of the offer includes monitoring social media sites associated with the customer. According to one embodiment, monitoring the social media sites includes capturing posts associated with the entity or the entity's products or services. According to one embodiment, monitoring of the social media sites includes sites associated with the customer and sites associated with the customer's connections.

According to one embodiment, the insight engine is configured to identify a target group to receive a notification regarding conversion of the offer to influenced connections of the customer. According to one embodiment, the generation engine is configured to generate the action such that the customer is required to publish a notification regarding the entity. According to one embodiment, the tracking component is configured to parse social postings to identify postings associated with the customer or a customer connection and the entity, entity's products, or entity's services. According to one embodiment, the insight component is configured to define customer activity scenarios associated with the actions. According to one embodiment, the insight component is configured to determine that at least one customer activity scenario has been performed. According to one embodiment, the insight component is configured to define a number of actions required to include in the customer activity scenario, based on data obtained from the at least one of the at least one CRM platform and the at least one aggregation platform, and the at least one social platform.

According to one embodiment, the system is configured to detect customer activity matching the defined scenario and communicate a trigger to the generation engine identify the matching scenario and any associated insight. According to one embodiment, the insight component is configured to modify the customer activity scenario responsive to customers redemptions associated with the action.

According to one embodiment, the generation engine is configured to generate the action responsive to the matching scenario. According to one embodiment, the generation engine is configured to tailor the action based on the customer activity scenario and on context associated with the customer activity scenario. According to one embodiment, the generation engine is configured to tailor the action based on the customer activity scenario and on connection information for the customer. According to one embodiment, the generation engine is configured to tailor the action based on a customer segment associated with the customer.

According to one embodiment, the system further comprises a publication component configured to publish an acceptance of the offer. According to one embodiment, the publication component is further configured to target publication of the acceptance of the offer to a segment associated with the customer.

According to one aspect, a computer implemented method for managing an entity's social graph is provided. The method comprising accessing, by a computer system, customer data from at least one of: at least one CRM platform and at least one aggregation platform, accessing, by the computer system, social media information from at least one social platform, segmenting, by the computer system, a customer population into a plurality of segments, based, at least in part on the customer data and social media information, generating, by the computer system, an insight for at least one member of the customer population within at least one of the plurality of segments, responsive to activity identified in the social media information and customer data, and generating, by the computer system, an action responsive to the insight.

According to one embodiment, the method further comprises communicating the action to the at least one CRM platform, wherein the action is configured to cause the CRM system to deliver an offer to the at least one member of the customer population based on the action. According to one embodiment, the method further comprises tracking redemption of the offer. According to one embodiment, tracking the redemption of the offer includes monitoring social media sites associated with the customer. According to one embodiment, monitoring the social media sites includes capturing posts associated with the entity or the entity's products or services. According to one embodiment, monitoring of the social media sites includes sites associated with the customer and sites associated with the customer's connections.

According to one embodiment, the method further comprises targeting a notification regarding conversion of the offer to influenced connections of the customer. According to one embodiment, generating the action includes generating the action such that the customer is required to publish a notification regarding the entity. According to one embodiment, the method further comprises parsing social media to identify postings associated with the customer or a customer connection and the entity, entity's products, or entity's services. According to one embodiment, the method further comprises defining customer activity scenarios associated with the actions. According to one embodiment, the method further comprises determining that at least one customer activity scenario has been performed.

According to one embodiment, the method further comprises defining a number of actions required to include in the customer activity scenario, based on data obtained from the at least one of the at least one CRM platform and the at least one aggregation platform, and the at least one social platform. According to one embodiment, the method further comprises detecting customer activity matching the defined scenario and communicate a trigger to the generation engine identify the matching scenario and any associated insight. According to one embodiment, the method further comprises modifying the customer activity scenario responsive to customers redemptions associated with the action.

According to one embodiment, generating the action includes generating the action responsive to the matching scenario. According to one embodiment, generating the action includes tailoring the action based on the customer activity scenario and on context associated with the customer activity scenario. According to one embodiment, generating the action includes tailoring the action based on the customer activity scenario and on connection information for the customer. According to one embodiment, generating the action includes tailoring the action based on a customer segment associated with the customer. According to one embodiment, further comprises publishing an acceptance of the offer. According to one embodiment, the method further comprises targeting the publication of the acceptance of the offer to a segment associated with the customer.

Still other aspects, embodiments, and advantages of these exemplary aspects and embodiments, are discussed in detail below. Any embodiment disclosed herein may be combined with any other embodiment in any manner consistent with at least one of the objects, aims, and needs disclosed herein, and references to “an embodiment,” “some embodiments,” “an alternate embodiment,” “various embodiments,” “one embodiment” or the like are not necessarily mutually exclusive and are intended to indicate that a particular feature, structure, or characteristic described in connection with the embodiment may be included in at least one embodiment. The appearances of such terms herein are not necessarily all referring to the same embodiment. The accompanying drawings are included to provide illustration and a further understanding of the various aspects and embodiments, and are incorporated in and constitute a part of this specification. The drawings, together with the remainder of the specification, serve to explain principles and operations of the described and claimed aspects and embodiments.

### BRIEF DESCRIPTION OF THE DRAWINGS

Various aspects of at least one embodiment are discussed below with reference to the accompanying figures, which are not intended to be drawn to scale. Where technical features in the figures, detailed description or any claim are followed by references signs, the reference signs have been included for the sole purpose of increasing the intelligibility of the figures, detailed description, and claims. Accordingly, neither the reference signs nor their absence, are intended to have any limiting effect on the scope of any claim elements. In the figures, each identical or nearly identical component that is illustrated in various figures is represented by a like numeral. For purposes of clarity, not every component may be labeled in every figure. The figures are provided for the purposes of illustration and explanation and are not intended as a definition of the limits of the invention. In the figures:

FIG. 1 is a diagram of an example system for managing an entity's social graph, according to one embodiment;

FIG. 2 is an example process flow for managing a social graph, according to one embodiment;

FIG. 3 is an example conceptual model for processing connections within an entity's social graph, according to one embodiment;

FIG. 4 is an example process flow for generating a social graph for an entity, according to one embodiment;

FIG. 5 is an example process flow for identifying influencers within a social graph for an entity, according to one embodiment;

FIG. 6 is an example process flow for managing a social graph, according to one embodiment;

FIG. 7 is an example process flow for generating insights, according to one embodiment;

FIG. 8 in an example process flow for generating segments within a social graph, according to one embodiment;

FIG. 9 is a block diagram of one example of a computer system that may be used to perform processes and functions disclosed herein; and

FIG. 10 is a block diagram of one example of a computer system that may be used to perform processes and functions disclosed herein.

### DETAILED DESCRIPTION

As discussed above, provides are systems and methods for managing an entity's social graph of connections. The system can provide for integration between advertising networks, CRM systems, social media provides, as well any other available source accessible over a communication network, including, the Internet. The system can automatically generate insights regarding customers, and specific customer segments based on graphing connection available in CRM data, advertising data, and social data. Insights can be used by the system to develop optimal connection strategies, which can include advertising or offers for products and/or services.

According to one embodiment, the system is configured to monitor customers within an entity's social graph. Each customer can be a node within the social graph. In response to triggering events (e.g., a customer engages in an activity scenario identified on the system (e.g., visit competitor 3 times) define on the system, the system can take action. The system can be configured to determine automatically what the appropriate action should be. In one example, a determined action can include delivery of customer retention opportunities targeted to a user based on social media identification of visits to a competitor. In another example, multiple visits to a competitor can trigger offers to return to the entity being managed, including, for example, free offers that do not require purchase to redeem.

In one embodiment, insights into a social graph and/or an entity's connections can be used to automatically identify the multiple for the number of visits that should trigger the customer retention offer. Insight analysis can be automatically performed on CRM data, advertising data, and social media data to generate insights. In some embodiments, insights identify situations and/or scenarios in which an action can be taken. In other examples, the social graph information (including CRM data, advertising data, and/or social media data) can be used to identify visits to competitors, resulting in an opportunity to recapture a customer.

In some embodiments, communication channels can also be identified for population segments within a social graph. Communication channels can also be identified on a customer by customer basis. Insights into an entity's social graph can enable the system to identify automatically the best channel of communication for user segments and/or particular customers. User segments can include for example “new customer” segments, “repeat customer” segments, and/or “lost customer” segments. Each customer segment can be associated with a profile and/or behavioral characteristics that enable automatic identification of optimal approaches for targeting and interacting with a customer belonging to a particular user segment.

In one example, a demographic profile of a customer or group of customers is automatically developed by the system. Demographic profiles can include, for example, personal information, residence, education, income, wealth, assets, homeowner information, renting information, etc. In another example, behavior and user activity can be included in a psychographic profile. The system can generate psychographic profiles that include attributes relating to personality, values, attitudes, interests, and/or lifestyles, for example. In other examples, profiles can incorporate elements of any combination of demographic and psychographic profile attributes.

According to one embodiment, the system for managing an entity's social graph can generate optimized ad strategies which can be automatically generated based on collected information. Optimized strategies can be implemented and executed across a plurality of advertising channels, social networking sites, search engines, etc. Monitored activity within the social graph of the entity can also be used to identify CRM flags or action flag. In one instance, a CRM flag defines an opportunity to engage and/or retain a contact. Contacts can include potential customers, potentially lost customers, existing customers, among other options. CRM systems are configured to the manage relationship with clients and customers. A CRM opportunity occurs when there is a chance to improve the relationship and/or re-establish the relationship. In some examples, a CRM opportunity can include a free offer, or an incentive intended to induce the customers into strengthening or renewing a relationship with an entity.

Monitored activity can include social activities of customers, responses to advertising, profile analysis based on social media polling, behavior profiling based on CRM data, for example. Social activity can be analyzed to determine that an CRM opportunity exists. Embodiments of the system can be configured to determine the best approach to engage the customer in response to the identified CRM opportunity.

In some embodiments, a social engagement engine can be further configured to trigger advertising responses based on data received on social activities. In one example, the social engagement engine triggers delivery of a free offer to a contact within an entity's social graph. Integration with CRM management operation permits the system for managing an entity's social graph to trigger CRM processes using identified CRM flags. CRM processes include direct customer contact, developing incentives, soliciting feedback from customers, as some examples. CRM processes also are configured to develop profile information to identify, for example, both satisfied and unsatisfied customers. Further, in some settings CRM systems can be configured to segment populations into levels based on satisfaction. Segmentation can include development profiles on the population that can be used to analyze and segment consumer populations. Further, the identified segments can also be used to develop and/or modify population profiles.

### Example System

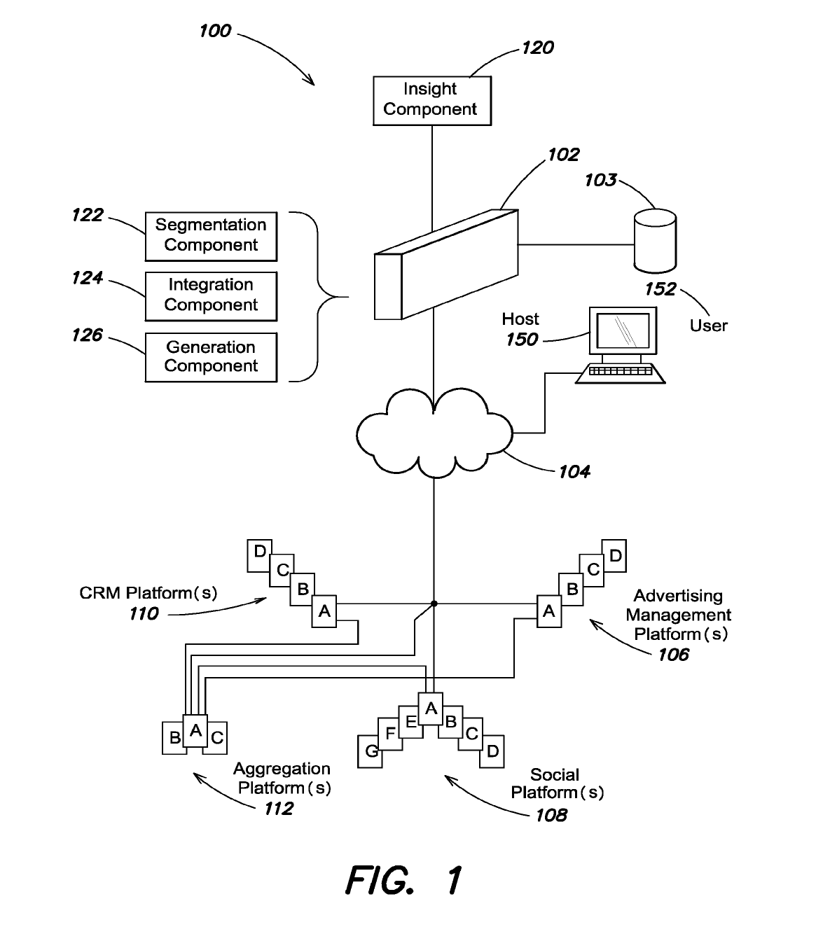

An example system for managing an entity's social graph is illustrated in FIG. 1. System 100, includes a server connected to a communication network 104 (e.g., the Internet). Server 102 can be a general purpose computer system specially configured as discussed herein. Server 102 can be connected to a plurality of advertising management platforms, e.g., at 106A-D. Each of the advertising management platforms can include a plurality of computer systems that are operatively coupled and configured to provide the advertising platform. Various underlying architectures can be implemented for any of the advertising management platforms (client/server, distributed, peer networks, stand alone systems, etc.). Server 102 can be configured to connect to available advertising management platforms to capture available advertising information. Server 102 can be further configured to request data from any of the available advertising management platforms in whatever format the platform provides. In some embodiments, system 102 can be configured with registration information that permits access to an associated advertising management platform. In other embodiments, advertising management platforms can be configured with communication information for server 102, and automatically deliver advertising data for analysis.

In some further embodiments, server 102 can execute processes for connecting to a given advertising management platform, accessing data management systems made available on the advertising management platform, and retrieving subsets of available data, as needed. In other settings, server 102 can be configured to receive data streams from connected advertising management platforms. Some embodiments of a system for managing an entity's social graph can include a server 102 configured to poll, query, accept streamed data, accept real-time data, batch process data, as needed, to communicate with any number of connected advertising management platforms, e.g., 106A-D. Some examples of advertising platforms that can be connected to server 102 include for example, the well-known GOOGLE ADWORDS platform, YAHOO! ADVERTISING platform, and MICROSOFT ADCENTER, among other available advertising platforms. An example advertising management platform is described in co-pending U.S. patent application Ser. No. 11/960,922, entitled “SYSTEM AND METHOD FOR MANAGING A PLURALITY OF ADVERTISING NETWORKS,” filed on Dec. 20, 2007, incorporated herein by reference in its entirety. In some embodiments, server 102 can include an integration component configured to manage communication between server 102 and any connected advertising management platform.

The integration component can be software stored on and/or accessed by server 102. Server 102 can be constructed with one or processors coupled to a memory. The one or more processors can be configured to execute the software to provide seamless access to a plurality of advertising management platforms.

Integration component 124 can include one or more APIs that are configured to communicate with one or more advertising management platforms. In some examples, data typing can be enforced by the API specific to an advertising management platform. In other examples, user interface features can be executed automatically by the API to permit server 102 to automatically access functions and/or data available on the advertising management platform as if an authorized user was making requests on the advertising management platform. Integration component 124 can include a plurality of APIs and/or a plurality of configurable functions tailored to specific advertising management platforms. Advertising platforms can be identified by source information and/or connection information used to communicate with the advertising management platform. Server 102 can be configured to automatically identify an advertising management platform and execute specific functions for the given advertising management platform.

In some embodiments, the integration component can be configured to store profile information on each advertising management platform. The profile information can include details on the functions, management features, generation mechanisms, analysis features, data type, and data formats available on the advertising management platform, among other options. In some further embodiments, the integration component can be configured to update profile information on each advertising management platform according to functions and/or features that are or become available.

Conventional advertising management platforms can be configured to generate advertisements delivered over a plurality of advertising channels, monitor existing advertisements, optimize advertisements, aggregate advertising information, group advertisements into hierarchical arrangements for easier management and monitoring, identify costs associated with advertising, calculate cost per click, click-through rates, identify conversions, establish conversion rates, manage budget funds for advertising, report aggregate data, analyzed data, and report raw data on advertisements, advertising campaigns, and/or advertising networks among other options. Each of these functions can be accessed by server 102 and used individually, collectively and in any combination to enhance the management of an entity's social graph.

Server 102 can also be configured to capture data from CRM platforms, e.g., 110A-D. The architectures of the given CRM platform can be configured according to any model architecture (e.g., client-server, distributed, multi-programming, multi-processing, peer to peer, stand alone) and server 102 can connect to the available CRM platforms over communication network 104. CRM platforms can include user populations that employ the CRM platform to receive CRM services. CRM services can be configured to allow an entity (e.g., a corporation) the ability to more effectively manage customers, resolve customer issues, retain and/or capture new customers. Known CRM platforms can include CONSTANT CONTACT, SALESFORCE, MICROSOFT DYNAMICS, SUGAR CRM, and PEERINDEX, for example. In other embodiments, other CRM platforms or systems that perform CRM functions can be used.

Server 102 can be configured to access information on any CRM platform. In some examples, a user inputs authentication information which can be stored on server 102. Server 102 is configured to access CRM platforms automatically to obtain CRM data. In some examples, server 102 employs authentication information specific to an entity to obtain CRM data specific to that entity. In some embodiments, server 102 can also be configured with a integration component 124. The integration component can be software stored on and/or accessed by server 102, and execute at least one process, when executing is configured to permit seamless access to a plurality of CRM platforms.

Integration component 124 can include one or more APIs that are configured to communicate with one or more CRM platforms. In some examples, data typing can be enforced by the API specific to a CRM platform. In other examples, user interface features can be executed automatically by the API to permit server 102 to automatically access functions and/or data available on the CRM platform as if an authorized user was making requests on the CRM platform. Integration component 124 can include a plurality of APIs and/or a plurality of configurable functions tailored to specific CRM platforms. Well-known platforms can be identified by source information and/or connection information used to communicate with the CRM platform. Server 102 can be configured to automatically identify a CRM platform and execute specific functions for the given CRM platform. In some embodiments, the integration component can be configured to store profile information on each CRM platform. The profile information can include details on the functions, management features, generation mechanisms, analysis features, data type, and data formats available on the CRM platform, among other options. In some further embodiments, the integration component can be configured to update profile information on each CRM platform according to functions and/or features that are or become available.

Conventional CRM platforms can be configured to generate customer contact media (e.g., offers, advertisements, custom messages) delivered over a plurality of communication channels, monitor existing customer relationships, identify lost relationships, aggregate data collected on customers, purchases and/or customer activity, identify costs/reward for delivery of contact media to a customer, manage retention opportunities based on budget thresholds, budget funds for customer retention, report aggregate data, report analyzed data, and report raw data on customers, purchases and other tracked activity, among other options. Each of these functions can be accessed by server 102 and used individually, collectively and in any combination to enhance the management of an entity's social graph. Further integration component 124 can be configured to access custom features available on CRM platforms.

Server 102 can also be configured to access information on any connected online aggregation/intelligence platform. In some examples, a user inputs authentication information which can be stored on server 102. Server 102 is configured to access aggregation platforms 112A-C and/or used accounts on the aggregation platforms automatically to obtain aggregated and/or analyzed data. For example, aggregation and/or intelligence system can be configured to analyze a level of impact an individual has on their social connections. For example, aggregation systems can determine for customers and/or potential customer populations how many people are influenced, how significant is the level of influence, and how influential those influenced people are. In some embodiments, scores for each factor can be determined for individuals, populations, etc. In some embodiments, an aggregate score can also be determined

In some examples server 102 employs authentication information specific to an entity to obtain aggregate data for that entity. In some examples, the aggregate data can be specific to customer populations for that entity. In some embodiments, server 102 can also be configured with a integration component 124. The integration component can be software stored on and/or access by server 102, and execute at least one process, when executing is configured to permit seamless access to a plurality of aggregation platforms. Some known aggregation platforms can include the well-known KLOUT and RAPLEAF systems. In other embodiments, other aggregation platforms or systems that perform aggregation/intelligence functions can be used.

Integration component 124 can include one or more APIs that are configured to communicate with one or more aggregation platforms. In some examples, data typing can be enforced by the API specific to an aggregation platform. In other examples, user interface features can be executed automatically by the API to permit server 102 to automatically access functions and/or data available on the aggregation platform as if an authorized user was making requests on the aggregation platform. Integration component 124 can include a plurality of APIs and/or a plurality of configurable functions tailored to specific aggregation platforms. Well-known platforms can be identified by source information and/or connection information used to communicate with the aggregation platform. Server 102 can be configured to automatically identify a aggregation platform and execute specific functions for the given aggregation platform. In some embodiments, the integration component can be configured to store profile information on each aggregation platform. The profile information can include details on the functions, management features, generation mechanisms, analysis features, data type, and data formats available on the aggregation platform, among other options. In some further embodiments, the integration component can be configured to update profile information on each aggregation platform according to functions and/or features that are or become available.

In some embodiments, aggregation platforms 112A-C can be connected to any one or more of CRM platforms 110, advertising management Platforms 106, and Social Platforms 108. Server 102 can be configured to access aggregation platforms 112A-C and/or the data generated by the aggregation platforms through the connections between the aggregation platforms and the any one or more of CRM platforms 110, advertising management Platforms 106, and Social Platforms 108.

Server 102 can also be configured to capture data from social platforms, e.g., 108A-G. Server 102 can connect to a variety of social platforms having a plurality of computer architectures. In some embodiments, the connected platforms can have multiple designations and can be configured to operate as any one or more of a social platform, CRM platform, and/or advertising management platform. The well-known FACEBOOK system can be accessed as a social platform, however, a plurality of advertising management features are made available on the platform. In other embodiments, the designation of the platform can be exclusive, and in others, non-exclusive and a given platform can be a social, CRM, and advertising management platform, as an example. Other well-known social platforms can include LINKED IN, TWITTER, GOOGLE+, FOURSQUARE, YELP, etc. Social platforms can be configured according to any model architecture (e.g., client-server, distributed, multi-programming, multi-processing, peer to peer, stand alone) and server 102 can connect to the available social platforms over communication network 104. Social platforms can include user populations that employ the social platform to receive social services. Social services are designed to allow a user the ability to easily interact with social connections, corporate connections, receive news and/or media according to defined preferences, and experience media and/or news according to defined preferences, which can include friends' preferences. Social services can also be configured to allow users to interact at unprecedented levels online, as groups, as friends, reach wider audiences, and/or participate in events far outside conventional channels.

In additional to being a tool for reaching out, a social platform gives significant access into, for example, user's activities, preferences, and behavior. Communications can be targeted to users based on their activities within the social platform. User behavior can be tracked, and media delivered based on user profiles, user tracked behavior, among other options. Relevant media can be provided, for example, on user interfaces associated with the social platform. In some examples, relevant media can be determined in conjunction with information provided by an aggregation platform.

Conventional social platforms include functionality for publishing online likes, dislikes, preferences, photos, activity, journal entries, activity logs, as well as the ability to comments on any of the preceding posted by other users. These data points can be accessed by server 102 through management features available on the social platform. In some embodiments, server 102 can be configured to capture these data points directly from communication with any of the social platforms. In other embodiments, server 102 can be configured with automated processes for capturing data from web pages, web sites, and/or other online display vehicles. In yet other embodiments, server 102 can be configured to capture the data points from CRM, aggregation, and/or advertising management platforms which can also be configured to track social data on users or customers. Server 102 can also be configured to access any of the available features on the social platforms, including for example, creating a social page for an entity, posting activity entries, publishing likes/dislikes, and the social platforms and any associated web pages can be used a communication channel for reaching customers or other entities.

In one embodiment, server 102 is configured to execute processes for identifying, defining, and/or managing a social graph for an entity based on the data received from advertising platforms, CRM platforms, aggregation platforms, and/or social platforms. An entity's connections can be initially defined on server 102 via a communication network (e.g., 104) connected to a host computer 150 displaying a user interface to a user 152. The user interface can be configured to communicate user input data to server 102 regarding the entity. In one example, the user can input information about existing connections. In another example, a user can input access information for existing connection information. Server 102 can employ the access information to connect to any platform (e.g., 106-110) and retrieve data on existing connections.

In some examples, server 102 can employ user defined connections to parse available advertising data, CRM data, aggregation data, and social data. Captured data can be analyzed by the system to further define characteristics of the connection. Server 102 can also employ groups of connections, connection pathways, and/or groups of connected entities to identify data associated with the groups and/or connection paths within advertising, CRM data, aggregation, and social data. Server 102 can also be configured to obtain connection information from any input user information, which may pertain to an entity, an individual, a connection, an advertising channel, etc. In one example, a connection can define a relationship between a corporation providing services and/or products and a customer receiving the services and/or products. Server 102 can employ the connection to identify additional information on the connected customer. For example, social data associated with the customer can be processed to identify the customer more specifically. The social data associated with the customer can be processed to identify a behavior profile of the customer and generate insights on how to improve the connection between the corporation and the customer based on the behavior profile. In some embodiments, an insight can include an indicator of customer behavior that can be responded to by the server 102. In one example, social media postings can reflect visits to a competitor. The server can be configured to respond to this insight, by delivering a targeted offer to the customers. In some settings, server 102 can deliver the offer directly. In settings, server 102 can trigger delivery of the targeted offer by any one or more of the connected advertising management and/or CRM platforms. In other examples, advertising data, aggregation data, or CRM data associated with the customer (e.g., reflecting likes, dislikes, brand preferences, etc.) can yield the same type of insight. In some embodiments, insights generated from both data sets (in one example, between social media and CRM data sets) can match. The system can identify matching insights and prioritize used of matching insight over others. In one embodiment, matching insights can reflect with a higher degree of confidence that the insight is accurate. In one example, the system can implement such insights to favor those having a higher degree of confidence. Server 102 can be configured to generate automatically actions in response to insights. Insights can be generated on direct connections (e.g., customers of a corporate entity) and can also be generated on indirect connections (e.g., friends of the customers).

In one embodiment, server 102 can be operatively connected to an insight component 120. In one embodiment, insight component can be a software process configured to execute on server 102, on the one or more processors installed of server 102. In another embodiment, insight component 120 can be configured as a separate processing entity, with its own processor(s) and memory. In one example, server 102 and an insight component can communicate data to determine insights from advertising, CRM, aggregation, and third party data. In another example, insight component accesses information on server 102 to analyze data and determine insights.

Insight component can be configured to execute various processes to determine insights from social graph data. The social graph data can include advertising data, CRM data, aggregation, and/or social data obtained from connected platforms. In addition, social graph data can include user input information. In one example insight component 120 can execute example process 700 for generating insights, discussed in greater detail below. Insight component can be configured to analyze data retrieved from any connected platform. In some embodiments, the received data can be stored locally on server 102 on one or more databases (e.g., 103) or one or more database servers connected to server 102. In other embodiments, insight component 120 can be configured to retrieve data on demand from any one of the connected platforms. In yet others, an insight component can be configured to operate using a mixture of local data and actively retrieved data.

In one embodiment, an insight component can be configured to identify connections within an entity's social graph and the end-points of the connections to determine and capture available advertising, CRM, and social data associated with the connections and the end-points. In one example, end-points of connections in the graph represent internal nodes in the graph or leaf nodes in the graph, either can be associated with an entity, a user, a consumer, or other persons.

Using the available data, triggers can be generated to take automatic actions on, for example, customer behavior, customer activity, customer preferences, among other options. The field of available data (e.g., advertising, CRM, and social data) can be expanded, for example, based on connections to connections. Connections, connections of connections, connection pathways, advertisements, advertising channels, can be used to define a social graph for an entity. The defined social graph enables a system for managing an entity's social graph to generate insights and responsive actions within the entire social graph. In some embodiments, the system for managing an entity's social graph is configured to allow an entity to manageably interact with a vast social network. The system can be configured to reduce the complexity of managing advertising and customer relations management by generating insights from the social graph data and responding to the insight with automatic actions.

In one embodiment, server 102 can also include a generation component 126 configured to generate action items in response to analyzed data and/or identified insights. In one embodiment, generation component 126 can be invoked by processes for managing an entity's social graph. In one example, a generation component can receive insights from an insight component 120. In response to the received insight, a generation component 126 can generate an action. In some embodiments, the action can include delivering an offer targeted to the customer associated with the insight, and the action/offer can be contextually matched to insight identified. An example insight can be identified from activity taken in a social media setting, including downloading favorite recipes over a period of time.

For a customer within an entity's social graph, that behavior information can captured by, for example, server 102. An insight component (e.g., 120) can analyze the behavior, identify CRM activity (e.g., previous appliance purchases by the customer from the entity) and generate an insight regarding a cooking preference. A generation component (e.g., 126) can then identify an action to take in response to the insight. In one example, a 10% off coupon can be generated and delivered to the customer for appliances sold by the entity. In another example, the coupon can be targeted to a specific appliance matching a need identified from past purchases from the entity. In further examples, the need identified is aligned by the analyzed behavior and past purchase information. In some examples, a specific need can be identified by one of the insight component or generation component based on social or advertising data.

In some embodiments, notifications can be delivered to connections regarding an action taken with respect to a customer. For example, targeted notifications can be delivered to the connections of the customer. For example, the system can generate a message to connections of the customer: “customer received this offer, would you to receive an offer?” The offer can be specifically tailored to the customer's connections. In some embodiments, the notifications can be delivered to influences connections of the customer. In other embodiments, the notification can be triggered responsive to the customer redeeming the action.

The generation component can also be configured to determine what system to employ to deliver a particular action. The determination for the delivery system can be based on engagement behavior for the customer. In some embodiments, the insight component can be configured to determine engagement behavior for a customer, a contact, a connection, or other element within a social graph. Engagement behavior can include information on what communication channels the customer is likely to respond to, what types of offers are reviewed by the customer, and can include customer preferences, etc. In some embodiments, the generation component identifies an action (e.g., send an offer to customer), determines a platform to complete the action (e.g., one of the connected CRM platforms), and communicates the action to the platform. In one example, a CRM platform can be configured to determine details for the given action, including a value associated with the offer, a brand, a specific appliance, etc. The generation component can also be configured to generate an action based on CRM analysis available from a CRM platform. For example, the CRM platform can include information on a potential value for a customer, and responsive actions generated by the generation component can be tailored to the potential value.

In some embodiments, a connection to a customer can be used to generate social endorsements of a particular entity. The server 102 can be configured to deliver “endorsed” media to the customer's connections as an action responsive to a given insight. Endorsed media can include tags and/or associations with the customer whose contacts are being targeted. In some settings, a thumbnail image can be delivered with the endorsed media picturing the customer. In other settings, a quotation from the customer can accompany endorsed media delivery. Endorsed media can improve the effect of the delivered media, by allowing the delivered material to leverage any good will associated with customer. Customer segments can be identified and targeted within the social graph of a particular entity and endorsed media targeted to identified customer segments. In some embodiments, segments can also be identified within a customer's connections. Endorsed media can then be delivered to a segment that is determined to be most receptive to the media and/or the endorsement from the customer.

Server 102 can be connected to other systems that host media for delivery. Further, each of the CRM platforms and/or each of the advertising management platforms can have media available for delivery. Server 102 can be configured to select from available media hosts on one of the platforms (e.g., 106-110). In some embodiments, server 102 can be configured to generate media for delivery. Generation of media can include incorporating media available from connected platforms (e.g., 106-110). In some settings, various elements can be retrieved from multiple platforms and integrated for delivery by server 102.

The results of any delivered action can also be monitored within the context of the entity's social graph. In particular, the customer's response to the offer (e.g., reviewed, ignored, redeemed, timing associated with the preceding) are monitored. The additional information can be used to further extrapolate behavior patterns on new customers, repeat purchasers, lost customers, etc. In some embodiments, server 102 can include a segmentation component 122 that identifies customer segments. Segmentation of connections, groups of connections, groups of entities, etc., enables some embodiments to more efficiently process generation of insights, management of a social graph of an entity, and generation of actions. Segments can be associated with profiles that define predictions on behavior, identify behavior patterns, identify communication channels, define predictions on responsiveness. Actions and identification of insights can be generated based on segments and a generation component 126 and an insight component 120 can be configured to employ segments when determining respective insights and/or actions.

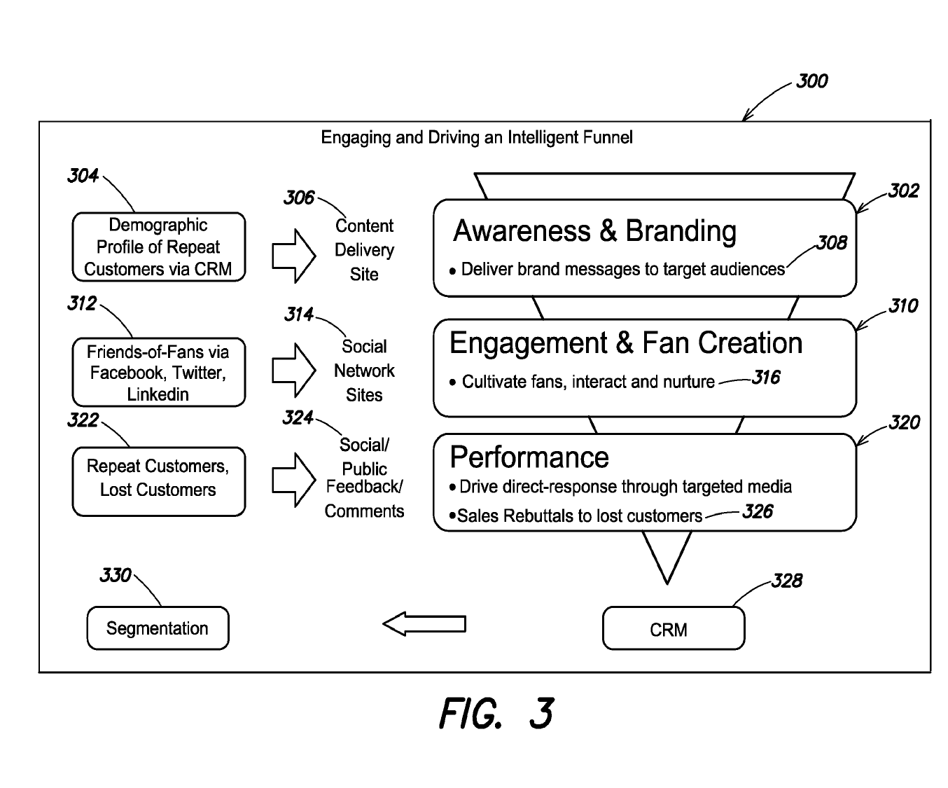

According to one aspect, systems and methods for managing an entity's social graph can be configured to executed processes for engaging and driving creation of an entity's social graph. A conceptual model 300 of the processing employed is shown in FIG. 3, providing a funneling of the connections and information that comprise the entity's social graph. At one level 302, branding and awareness of branding efforts (e.g., delivered and monitored on advertising management platforms and/or CRM platforms) enables definition of demographic profiles of customers (e.g., at 304). For example, media delivered via the well-known YOUTUBE system can target brand messages to specific audiences. The interaction of the targeted audiences with the media can be monitored and processed (e.g., on content delivery sites at 306) into profile and/or segmentation information. Various segments of customer populations can be identified. One example segment includes a repeat customers segment (e.g. at 304).

The behavior of repeat customers can be stored as part of a repeat customer profile. In addition, characteristics of the repeat customer segment can also be stored as part of a segment profile. In some embodiments, a CRM platform can be configured to develop customer profiles and defined characteristics of types of customers. Customer targets and/or target populations can be identified by a system for managing an entity's social graph and used, for example, to deliver brand messages to target audiences at 308. The customer targets can be engaged via social platforms. In some examples, an entity page can be automatically generated and configured via automatic mechanisms to develop fans, connections, and other social interactions.

At another level, profiles and demographic information is used on the system for engagement and “fan” creation, e.g., at 310. Fans can include individuals on social media systems who “like” a page or otherwise publically evidence a positive affiliation with an entity (e.g., through likes, positive reviews, pins, or other social media acknowledgements). In one embodiment, fans can actively be solicited based on profile information determined from information captured by the system (e.g., from a CRM platform, or other system). In addition, fans can actively be solicited based on existing connections to an entity. In one embodiment, friends of existing fans are identified and solicited (e.g., at 312). In one example, solicitation messages are delivered to an existing fan's connections in the social graphs. As discussed, the existing fans connections can be discovered by the system during analysis of CRM data, social data, aggregation data, etc.

According to one embodiment, the social graph management system can be configured to nurture, automatically, connections to an entity (e.g., fans, friends-of-fans, etc., direct connections, and/or indirect connections, among other examples). The system can be configured to deliver awards, reminders, and/or offers to increase interaction. The awards, reminders, and/or offers can be specifically targeted to individuals based on available social media information, among other options. The performance of the solicitations for fans, friends-of-fans, direct, and/or indirection, and the performance of awards, reminders, and/or offers can be monitored, to improve responses of the targeted audience (e.g., by monitoring social sites at 314). The combined information and performance associated with specific solicitations can be used to target engagement and facilitate fan creation (e.g., at 316)

In another level, performance information can be monitored in associated with information captured from prior levels (e.g., 302 and/or 310), for example, as part of level 320. In one example, the performance data can be used on the system to drive direct-response through targeted media. In another example, performance data can also used on the system to generate automatically sales rebuttals to lost customers (e.g., at 326).

According to one embodiment, tracked social data enables the system to respond automatically to adverse experiences. Postings on the known YELP system review experiences with service providers and/or products. The system can be configured to capture data posted on the YELP system (e.g., at 324), identify its association to a managed entity, service, and/or product. In one embodiment, insight analysis and action generations enables the system to automatically respond to negative experiences. Lost customers (e.g., 322) may publish their negative opinion of the service and/or product. The system can be configured to publish rebuttals automatically. Further, the system can be configured to target offers to the lost customer to attempt to regain the connection with the customer. In some embodiments, identification of activity by a lost customer can be used to further refine a lost customer profile (e.g. 322).

Each of the experiences, and the information associated with a customer experience, and/or social experience can be used to determine insights that enable the system to more efficiently manage an entity's social graph. In some settings, customer experience data can be tracked on a CRM platform (e.g., 328) and/or used to trigger CRM actions. The raw data, and/or analyzed data on the interactions can be used to identify segments (e.g., at 330) within an entity's social graph. The segments can generate groups for repeat customers and lost customers, for example, and enable the system to identify opportunities effectively and to take actions to improve any relationship with either group via insights and generated actions. According to some embodiments, new information acquired from the various data sources can be processed according to the model illustrated or the various functions and processes disclosed herein. The system can be configured to dynamically update profile information for customer segments, for customer profiles (e.g, lost, new, current, valued, etc.), for segments generated within a customer's sphere of influence, friends of customers, segments within friends of customers (identified in some embodiment by any social media connection—re-pin of material on the known PINTEREST, like on FACEBOOK, re-tweet on TWITTER, 1^{st}, 2^{nd}, or 3^{rd} degree connection on LINKIN, group on FOURSQUARE, etc.).

According to one embodiment, a system for managing an entity's social graph is configured to manage the social graph for a coffee product provider. For an entity that is first registered on the system, the system can be configured to request information on existing social connections, existing advertising platforms, and/or existing CRM platforms. If an entity has not yet established a social presence on a social platform, an advertising management platform, and/or a CRM platform, the system can be configured to automatically generate accounts on available providers. In one example, the system can automatically generate a FACEBOOK system account for the coffee provider. Using any one of FACEBOOK system's advertising options, an advertising platform's ad campaign management, and/or a CRM platform's advertising delivery system, advertisements can be delivered through the FACEBOOK page created for a coffee provider. In one embodiment registration is all that is required for the management system to automatically create a social presence, perform search operations on social information (e.g., any publically available information referencing the entity), capture CRM data, aggregation data, etc., capture review system endorsements, publish positive endorsements within the social presence, and/or solicit fans to build credibility of the social presence from any identified connections.

For an entity with existing social pages and/or social platforms, the system can capture existing information from any social platform regarding existing connections, including for example, e-mail addresses for leads and customers. Various social media sources can be identified by the system to capture additional data on the coffee provider. Known sites can be search for review information, customer opinion information, etc. on the coffee provider. Additionally, competitor information can be checked against connections within the entity's social graph.

The system can be configured to determine engagement behavior from the captured social media source. In some embodiments, engagement behavior can be used to determine influencers within target groups. Influencers can include customers who appear to direct, control, or influence the behavior of other customers. In a social graph example, these influencers can be identified by large number of connections. Influencers can also be identified based on responses to the influencers' activity on social media platforms. In one example, responses can be captured directly by the system from social media sites. In another example, responses can be identified by a CRM or advertising platform and communicated to the system. Connection information for a customer can be monitored by the system to determine the customer's ability to influence his or her connections. One should appreciate, that a large number of connections is not the only indicator of influence, indeed a small group of connections can include an influencer who directs, controls, and/or influences the behavior of the small group. Identifying influencers within the social graph for an entity, e.g., a coffee provider, enables the system to more efficiently target offers and/or awards to the influencer. Further, the system can more effectively target a group using endorsed media by invoking any goodwill associated with an influencer. The system can be configured to target the influencer in order to retain the influencer as a brand advocate. In one example, the influencer can then endorse delivery of media to the influencer's connections. In another example, the system can capture social endorsements by the influencer for further delivery.

Process 200, illustrates and example flow executed by a system for managing a social graph. Process 200 beings at 202, with analysis of CRM data and/or aggregation data against social connections to identify influencer segments at 203. Step 202 can invoke additional processes executed by the system to analyze data to identify influencer segments. For example process 800 discussed in greater detail below can be executed as part or in conjunction with 202 and in addition to identifying influencer, customers and/or potential customers can be identified based on populations segments and/or having a particular characteristic. Social, advertising, aggregation, and CRM data can be tracked 204 for indentified influencers. At 206, social postings detail a visit to a competitor's coffee house. The visit can be flagged by the system at 208. The flagged data can be analyzed to determine if a response is required at 210.

In one example, an insight component and/or a generation component can be configured to determine when the flagged activity requires a response. In some embodiments, responsive to a determination that a response is required, a generation component generates an action. An action can include, for example, delivery of a promotion offer, a loyalty reward, and an award with referral opportunities. At 210 YES, it is determined that a response is required. For example, the influencer may have made a third visit to the same competitor, triggering a customer retention response at 212. Any of a number of actions can be taken to improve a relationship between an entity and a customer. An example action includes delivery of a promotional offer for free coffee on the next visit to the coffee provider. In some examples, the offer for free coffee can include a requirement that the customer check-in at using the well-known FOURSQUARE to redeem the offer. In one alternative, the offer can include acceptance terms that permit the entity to check the customer in automatically at redemption of the offer. The check-in can be used to amplify the effect of the return visit to the coffee provider across social media connections, for example at 214.

At 214, a response to the action generated at 212 can be leveraged into social endorsement. In one example, an influencer can be directed back to the entity providing a promotion, and the return visit documented on a social platform. The documented visit (e.g., a check-in using the well-known FOURSQUARE system) can be used to establish credibility with the influencer's connections.

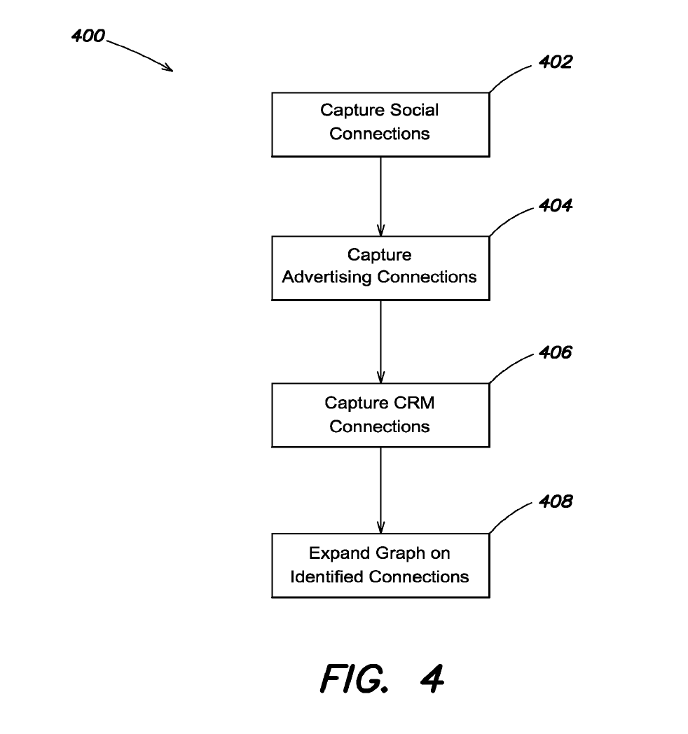

According to some embodiments, an entity registers with a system for managing an entity's social graph. The system is configured to generate a social graph based on information input by the registering entity. Shown in FIG. 4, is an example process for generating a social graph for an entity. Process 400 begins at 402, where any existing social connections for a given entity are captured. Capturing existing connections can include providing information associated with any social media accounts (e.g., FACEBOOK accounts), downloading metrics and/or information associated with any social media accounts, downloading information stored on e-mail services and/or client lists, any or all can be captured and used to identify connections. Marketing information can also be used to further define an entity's social graph. In particular, process 400 can continue at 404, where user(s) input information regarding advertising management platforms is used to capture advertising connections for the entity. If the entity has registered for any CRM platforms and/or aggregation platforms they can be identified and at 406 any information associated with them can be captured and integrated into the entity's social graph. In some examples, existing connection(s) can define an initial graph, which can be expanded based on connections within the graph. At 408, the connections defined at 402-406 can be further expanded based on further connections to the identified connections.

In some embodiments, 408 can be omitted, and the existing connections used to define an initial social graph for an entity, which can be used as part of a system and/or method for managing a social graph for an entity. In other embodiments, the initial social graph is expanded at 408 to increase the size and penetration of the entity's social graph.

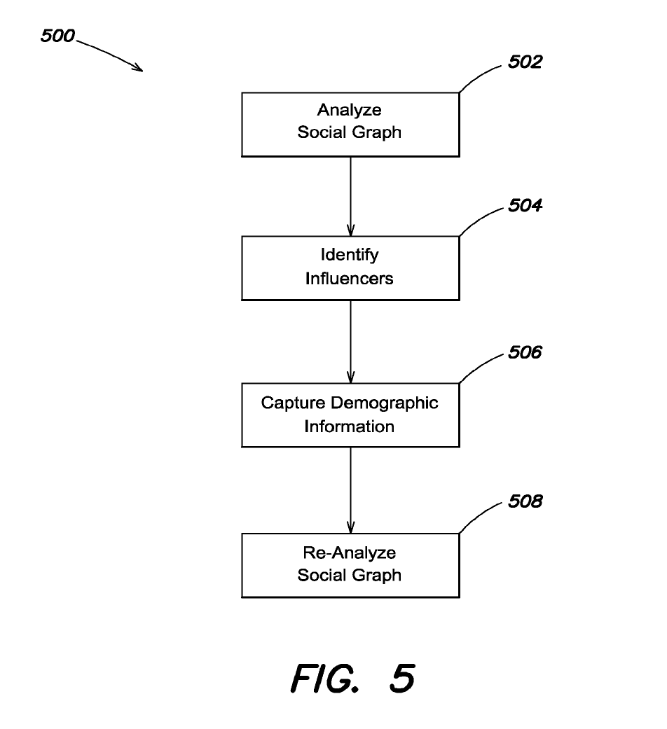

Shown in FIG. 5 is an example process 500 for identifying influencers within a social graph. At 502, all the data collected on a given entity defining the entity's social graph is analyzed. At 504, influencers within the social graph are identified. Influencers can be identified based on a number of connections, a number of followers, posting and response criteria, social activity, postings in social platforms, participation in specific social media platforms (in one embodiment participants on the FOURSQUARE social platform can be specifically identified), interconnections between participants, influencer scoring, how many people are influenced by an influencer, how significant is the level of influence, and how influential those influenced people are, among other options.

The system can be configured to capture information relating to any combination of the preceding characteristics to identify influencers. Some characteristics can include weights to have a greater effect on the determination of an influencer. Initial identifications of influencers can be used to define a profile for the identified influencers and/or groups within the identified influencers. In one embodiment, at 506, demographic information can be captured on the identified influencers. The captured demographic information can be used by the system to generate a profile for at least a portion of the identified influencers. The influencer profile can be used to re-evaluate the identified influencers and can also be used to re-evaluate the social graph for connections within the social graph at 508. Re-evaluation can identify additional influencers that were not initially identified but share common demographic information with the identified influencers.

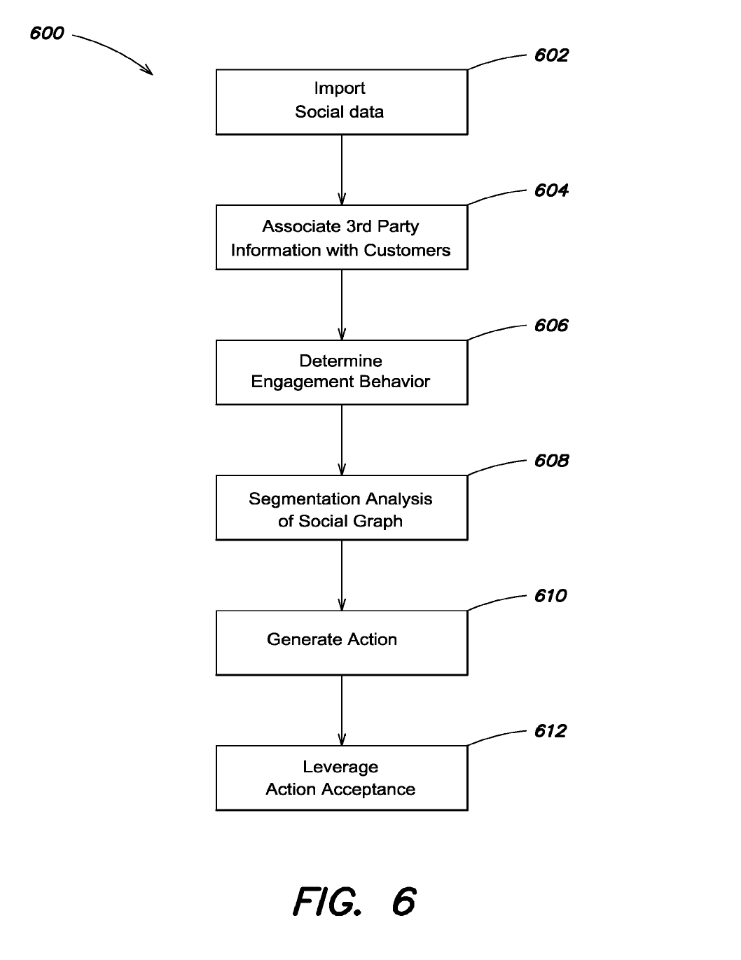

Identified influencer can be used by the system to further target customer retention/relationship building communications. Shown in FIG. 6 is an example process 600 that can be executed to manage a social graph for a given entity. At 602, a customer's social data is identified and imported into the system for managing a social graph. The nodes within the graph can include any number or all of the customers of the entity. At 604, third party information can be associated with the nodes in the social graph. In one example, customer information can be retrieved from connected platforms (e.g., social, advertising, aggregation, and CRM platforms) to associate additional information with customers in the social graph. In another example, details on potential customers or leads can also be identified. In yet another, details on an existing customer base can be associated with corresponding nodes in the social graph.

At 606, any nodes, the connections defined within the social graph, which can include customers and connections to the customers, and any information associated with either can be analyzed to define engagement behavior. At 606, engagement behavior of customers and any connections of customers is determined.

From the engagement behavior, influencers are identified. Influencers can include customers of the entity that impact and/or effect, for example, purchasing decisions by their connections. Influencers can also include customers having a large number of connections, and/or interconnections within the social graph. Social media data can be used to identify engagement behavior indicative of an influencer. In one example, reviews posted by an individual on the well-known YELP system, provide reviews and rating of products and/or services. Commentary indicating agreement and/or similar scoring can be automatically identified and used to determine individuals with the ability to influence others. In another example, the well-known YAHOO! ANSWERS system provides a platform on which questions and answers are submitted. The answers can be agreed to, liked, and/or supported with further commentary. Demonstrations of good answers (e.g., with a high number of likes and/or agree votes) can be used by the system to identify influencers. In another embodiment, an overlap between like and agreeing votes with connections to the individual can be used to identify an influencer and/or the influenced group. In some examples, influenced groups can be used to define segments.

At 610, actions can be generated to address, for example, customer retention opportunities. An action can be generated to include identified influencers within a given actions. In one example, an influencer for a customer can be identified to endorse a customer retention opportunity. Having a customer who influences the target deliver an action (e.g., promotional offer or opportunity) can lend credibility to the action and increase the likelihood of acceptance and/or redemption. In some embodiments, the system can be configured to determine the intersection between targeted customers and any respective influencers for the customer. For customers who have been identified as lost (in one example a customer whose social data reflects visits to a competitor can be identified by the system as lost) a number of influencers can be identified and employed to deliver opportunities to the lost customer by the generated action. By identifying influencers the system can increase likelihood of customer retention and/or recapture. Additionally, in some embodiments, if the opportunity is accepted, social media can be engaged to leverage the effect of the acceptance at 612. In one example, the action generated provides an offer to return to the entity. The return visit can be published on social media platforms, to influence any connections to the retained customer.

In one example, an appliance provider can register with a system for managing an entity's social graph. In one setting, the appliance provider can provide customer relations management information directly to the system. In another setting, the appliance provider can input registration information for a CRM platform, and the data can be captured from an already existing CRM provider. In one example, past purchase activity for the appliance provider's customer base are stored on the system. Other third party services can be queried and/or accessed to obtain additional detail on the customers making up the customer base. In one example, details on customer leads and/or past purchasers can be obtained and associated with the customer base information. Contact information can be captured as well as social media activity. The system can be configured to collect available social media data on the identified customer base, and can additionally be configured to collect available social media data on connections to the identified customer base.

The third party data and social media data can be analyzed to determine engagement behavior within the customer base. Further engagement analysis can include the connections to the customer base to identify influencers within segments of the social graph. As discussed above, various criteria can be employed by the system to identify influencers within segments of the customer base. Additional analysis can be performed across the collected data to generate segments within the social graph. For example, repeat customer segments can be identified. In another example, lost customer segments can be identified. Other examples segments can be generated, including new customers, potential customers, high volume customers, among others. Each one of the segments can be profiled for common demographics, common behavior, communication channels, influencers, etc. The profiled information can be used by the system to optimize targeting of offers and/or awards. Further, the profiled information can be used by the system to optimize marketing strategies across the social graph.

According to one embodiment, data available from social, advertising, and CRM platforms can include commentary authored by the customers on the YELP system, commentary about the customer's opinion, reviews posting on product postings, and/or questions and answers in discussion forms. The data can be analyzed by the system to determine how engaged a customer is with the entity and the entity's brand.

In another embodiment, a Software Provider can engage the system for managing an entity's social graph. In one example, a potential customer can be recognized by signing up as a follower on the LINKEDIN system. Views made by the potential customer of advertising can be tracked by third party systems (e.g., advertising management systems, CRM platforms, and/or social platforms) and analyzed to determine if the system should generate an action targeting the potential customer. Profiling of related customers and/or a profile developed from other potential customers can be used by the system to identify an optimal time to generate an action on the system. In one example, the system determines from available data that three views of financial software whitepapers are indicative of a product need by the viewer. In response to the third viewing, the system generates an action to target the potential customer. The action can include delivery of an offer to try a product matched to the viewed whitepapers. In this example, an offer to try a financial management tool is delivered. The offer is tracked to determine if the offer was accepted, appreciated, and/or completed. The tracked information can then be used to update any profile information for the potential customer profile, which can be applied by the system across all identified potential customers.

In another example, postings to discussion forums by a customer within the social graph can be identified. The system can be configured to determine that the topic of the forum relates to product and/or services provided by the entity. A CRM opportunity flag can be generated by the system, and an existing customer profile referenced to determine if an action should be generated. In some embodiments, actions are limited to scenarios where a positive outcome is more likely than not. The likelihood of a positive outcome can be determined from analysis by the system on the existing customer profile. In some examples, the customer can b first matched to an existing profile, and the matched profiled used by the system to determine the likelihood of a positive outcome (e.g., likelihood customer will convert an offer, accept an offer, complete an offer, etc.).

In some settings, initial contacts are not truly indicative of an actual intent to purchase, and thus, the system can be configured to limit action generation, to situations where multiple events or repeated events indicate a given action is appropriate. Multiple posts in a discussion forum regarding the entity's product or service can trigger the system to generate a customer support contact to the customer to resolve the discussed issue. In some examples, the system can be configured to generate an action configured to trigger the customer support interaction through a connection to one or more CRM platforms.

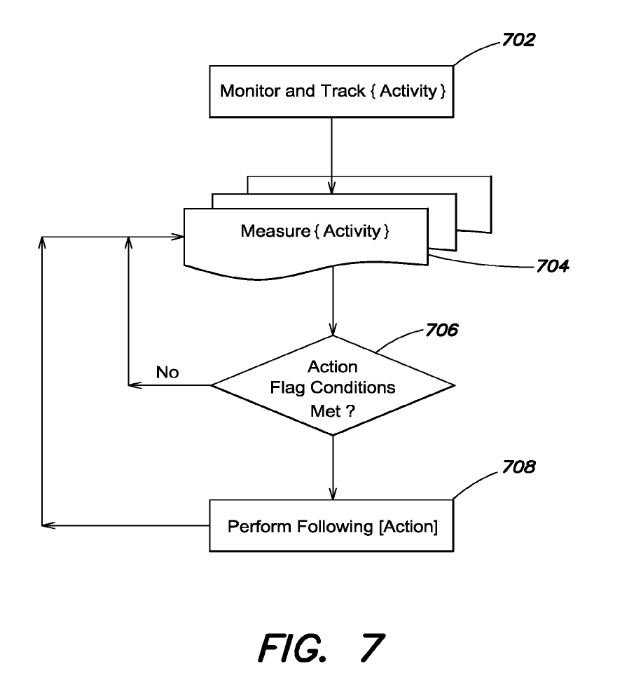

Shown in FIG. 7 is an example process 700 for generating insights. Process 700 can begin at 702 with monitoring and tracking all social graph activity for web properties of an entity. Web properties can include web based business, real world stores having online presences, real world stores with online purchasing, real world stores with online reporting, etc. At 704, measurements are taken against the tracked data to determine if a defined activity has occurred. In some embodiments, the defined activity can include a pre-defined action/activity taken by a customer of the entity. Customers and other connections to the entity can be track as part of the social graph of the entity. For example, postings on the YELP system by an identified customer can be tracked and/or monitored. Positive reviews and/or negative comments can be identified at 704 and then used to test against action flag conditions at 706. In some examples, a system can be configured to pull any postings matching an entity, determine if an action can be taken, and execute the action appropriately based on the match to the entity. If an action flag condition is met 706 YES, process 700 can include generation and execution of a responsive action at 708.

In some embodiments, each action and any effect can be tracked and/or monitored at 704 and process 700 can continue indefinitely generating and executing actions in response to action conditions based on measured activity or until terminated. If an action flag condition is not met 706 NO process 700 can continue to measure and/or analyze monitored activity.

In one embodiment, specific activities can be monitored and/or tracked at 702. For example, an entity with a social networking page can be tracked to determine if fan growth is occurring at a desired rate. Each person or entity that enters fan status on the social networking page can become a contact or node within that entity's social graph. At 704, fan growth can be measured and at 706 fan growth can be analyzed against a defined threshold to determine in fan growth meets the defined threshold. In some embodiments, the defined threshold can be a default value. In other embodiments, a user can set a value for fan growth. In yet others, historical analysis can be used to define a target growth rate.

In another embodiment, engagement quality can be measured and/or tracked at 702 within the social graph of an entity. Engagement quality can reflect how effective a channel or channels of communication are to reach a customer, client, potential customer, etc. Measurements of engagement quality can be used in multitude of settings. For example, low engagement quality (e.g., below a threshold at 706) can be used to generate and execute actions at 708, that cause a given communication channel to be abandoned, changed, and/or modified based on the generated activity.

According to some embodiments, various activities can be monitored within an entity's social graph. The various activities include, for example, identifying customer complaints, customer praises, and/or webpage activities. In one setting, customer complaints can be identified on a social networking page (e.g. the YELP system, or FACEBOOK accounts). The identification of a complaint can trigger an action at 708. In another example, the identification of positive feedback can trigger an action at 708. The actions can be tailored to the underlying activity that generated the action. For positive feedback, a sponsored story can be generated and published on a social networking site associated with the entity. In one example, the sponsored story can identify a customer who had a positive experience and quote from any comments received from the customer. In some examples, the actions can include targeted distributions of the sponsored story to connections of the customer.

In some embodiments, data can be pulled or pushed from various data sources (e.g., social, aggregation, CRM, advertising management platforms) to build patterns from the data, including any demographic information at 702. The data patterns can be used to identify influencers and/or characteristics that influencers have. The system can be configured to identify specific patterns within the data to identify how individuals or connections are connected to a specific company or entity. In some embodiments, data collection can be performed on closer connections to a company or entity in initial stages. The data collection and analysis can then be expanded to analyze connections of connections, etc. In some embodiments, the system is configured with pre-defined classifications in which data is collected (e.g., high income, high purchase volume, brand loyalty, etc.). Although, in other embodiments, the system is also configured to learn to classify collected data based on recursive analysis. Classification buckets can include, for example, category associations which describe how a brand for an entity and how the entity itself is associated with a respective category. Other examples, include products recommendations within a category, which can describe how many times and/or in what ways/context does a brand or product get recommended in a given category.

In some embodiments, classifications can be made on brand/entity differentiation, brand/entity visibility across the Internet, and/or customer experience with the brand/entity. Brand/entity visibility measures can track how searches are performed on branded or non-branded keywords associated with an entity's product or the entity's brand, which can be tracked globally or within a category. Customer experience with a brand/entity can be measured by tracking any reviews posted online and determining any sentiments contained therein (e.g., positive, negative, indifferent). In some examples, classification of the data can be verified based on statistical modeling to insure that data analysis and classification is executed correctly. In others, statistical modeling can be used to confirm learned classifications.

In some embodiments, data sources can be evaluated by the system to determine if the available data is significant or rich enough to permit a high level of confidence in any analyzed data. In some examples, analysis of an online forum will not occur if its membership is less than 5,000 members. In other examples, a social network source with less than 5 million connections will not be polled or searched for data. The system can be configured with various thresholds for limiting analysis of data. In some settings, an entity being managed can establish the threshold levels. In others, contextually dependent criteria are employed by the system to set the thresholds.

The system can also be configured to analyze received data to determine if the data received is significant. Various criteria can be established by default on the system. The criteria can also be configurable by a managed entity. In some examples, social feedback, comments, reviews, and other information can be analyzed by the system to determine if the information is a statistical outlier. If there is one negative review within 1000 reviews of a product, the system can determine the negative review is an outlier and ignore the negative review to determine the general sentiment about the product and/or company providing it. Various thresholds can be employed to determine statistical outliers.

In other examples, statistical outliers can be necessary to define maxima or minima values for boundary analysis. In these settings, for example, statistical outliers are used in determined bounds.

In some embodiments, a context of the received data can be evaluated to determine its relevance and/or significance. For example, post in an online forum regarding GE refrigerators can include off-topic posts about microwaves. The off-topic posts can be excluded by the system based on contextual analysis. In some settings, context cannot be determined due to incoherent or irrelevant information. Such irrelevant and/or incoherent submissions can be ignored by the system.

In another embodiment, customer complaints can be specifically identified by the system and actions generated and executed at 708. For example, the action can include generating a customer service follow up for an identified customer. Technical support can be contacted and requested to follow up on and resolve an issue identified for a customer.

In other settings, activities on a web site or page can be identified and actions can be generated and executed at 708. For example, a customer downloads a whitepaper on a product offered by the entity. At 708, a promotional e-mail can be sent to the customer with a coupon code.

Other activities can be tracked within an entity's social graph and additional actions can be executed in response to identified activity meeting, exceeding, and/or failing to meet defined thresholds.

In some embodiments, the system can be configured with an initial set of predefined action flags that trigger predefined actions. In some embodiments, the system can be configured with machine learning algorithms that modify the predefined action flags and/or the predefined actions according to tracking of responses, for example, at 702. The system can be configured to combine predefined actions into new actions. The system can be configured to generate new actions based on analysis of responses. Further, in some embodiments, an entity can input their own action flags and customized actions to take in response.

At 708, the actions can be performed. Tracking of redemptions and/or impact can be used by the system to determine if an action is effective or needs to be modified. Actions can be optimized by the system to leverage identification of influencers, population segments, etc. In some embodiments, managed entities can define goals associated with actions and/or action flags, and the system is configured to analyze customer patterns to determine an action that will achieve the desired goal. The system can tailor thresholds associated with the action and/or action flag based on tracking of the impact of the action on any customer population.

In some embodiments, the system can tailor threshold based on analysis of populations segments. Population segments can be generated by the system based on sets of defined behaviors. For example, a behavior can be deterministic in nature. For customers having a defined behavior, a particular action delivered to those customers has a significantly greater chance of leading to a positive outcome than the general population. One example, includes pre-sales behavior determined to lead to a greater likelihood of redemption of an offer. For customers who download 4 whitepapers from a company web-site on the company's product online, the system has determined that there is a 50% chance customers within that segment will convert an offer for a promotional coupon matching the products of the whitepaper if the customer is also a manager (or higher in the corporate hierarchy) in their respective company. Thus the system can define and refine segments based on monitored activity. In some embodiments, the monitored activity can also be combined with other data (e.g., advertising management, CRM, aggregation data) to further define and/or refine customer segments. In some embodiments, an entity and/or more specifically a company can have market research available that identifies optimal actions to take with respective customer populations. In some embodiments, an entity can establish on the system various customer segments, action flags, and/or actions to take with respect to either. The system can modify or refine entity defined segments, actions, and action flags.

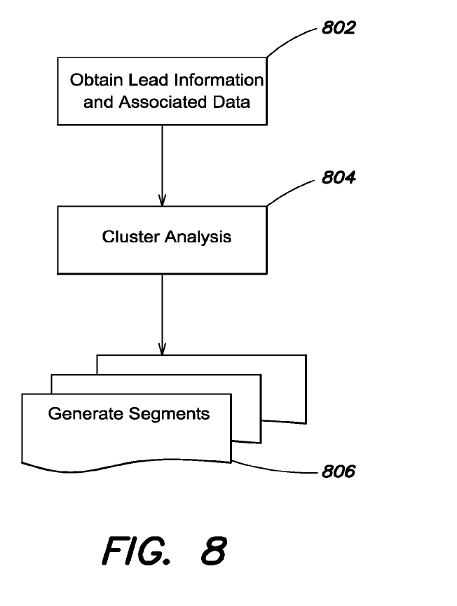

FIG. 8 illustrates an example process 800 for generating segments in a social graph. Segments can include customers and/or communication channel used to connect with customers, and or other data associated with an entity in a social graph. Past purchase behavior, sales conversions, sales data (e.g., how recent purchases were made, value of purchase, frequency of purchase, etc.) can be captured for an entity and stored for segmentation analysis. Third party data can be incorporated into the sales data for segmentation analysis. The third party data can include demographic information for customers and/or potential customers, social behavior for customers and/or potential customers, for example.

In one setting, process 800 can be executed against leads for a given entity. Each lead can be identified in a CRM system, where each lead represents a potential sale and/or a potential customer for the entity. At 802 the combined historical sales data, CRM data, and historical purchase data for an entity can be analyzed to identify distinct pre-sale, sale, or post sale behavior for customer populations.

Each behavior or sets of behaviors can be associated with populations within the identified leads. In some examples, the identified lead population includes existing customers, former customers, potential customers, etc. Each behavior or sets of behaviors can be associated with a customer profile. In some embodiments, the customer profiles can be predefined and may also reflect a value for a particular customer who matches the profile. The customer profiles can also reflect behavioral information, including responsiveness to actions.

At 804, lead, existing customer, and/or potential customer populations can be segmented based on a matching behavior or sets of behaviors. In some embodiments, customers can belong to one or more customer segments. At 806, the population segments can be stored and/or communicated to a system for managing a social graph. The segments can used by the system to deliver segment tailored offers, or other opportunities designed to have members of the segments perform actions. The specific behaviors used to define segments can be learned by a system, for example, based on historical analysis. In some examples, a system can be configured to apply learning functions to supplied social, CRM, aggregation, and sales data to identify behavioral characteristics that can be used to segment populations.

Various embodiments according to the present invention may be implemented on one or more specially programmed computer systems, including for example FIG. 1 system 100. These computer systems may be, for example, general-purpose computers such as those based on Intel PENTIUM-type processor, Motorola PowerPC, AMD Athlon or Turion, Sun UltraSPARC, Hewlett-Packard PA-RISC processors, or any other type of processor, including multi-core processors. It should be appreciated that one or more of any type computer system may be used to facilitate managing an entity's social graph and/or optimizing advertising intelligence according to various embodiments of the invention. Further, the system may be located on a single computer or may be distributed among a plurality of computers attached by a communications network.

A general-purpose computer system according to one embodiment of the invention is specially configured to perform any of the described functions, including but not limited to, creating, storing, parsing, matching, evaluating, and displaying a social graph for an entity, as well as analyzing any data captured for the members of the social graph, etc., and the invention is not limited to having any particular function or set of functions.

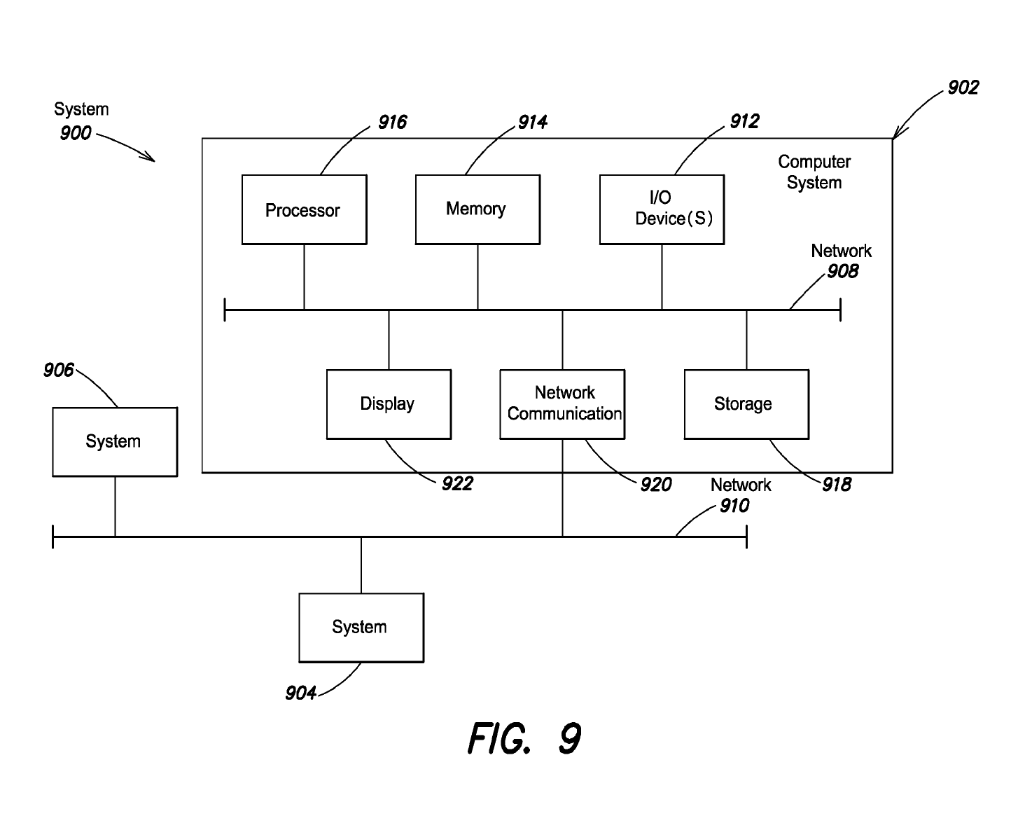

FIG. 9 shows a block diagram of a general purpose computer and network system 900 in which various aspects of the present invention may be practiced. For example, various aspects of the invention may be implemented as specialized software executing in one or more computer systems including general-purpose computer systems, 902-906, shown in FIG. 9. Computer system 902 may include a processor 916 connected to one or more memory devices 914, such as a disk drive, memory, or other device for storing data. Memory is typically used for storing programs and data during operation of the computer system. Components of computer system 902 may be coupled by an interconnection mechanism such as network 908, which may include one or more busses (e.g., between components that are integrated within a same machine) and/or a network 910 (e.g., between components that reside on separate discrete machines). The interconnection mechanism enables communications (e.g., data, instructions) to be exchanged between system components of the system.

Computer system 902 also includes one or more input/output (I/O) devices 912, for example, a keyboard, mouse, trackball, microphone, touch screen, a printing device, display screen (e.g., 922), speaker, etc. In addition, computer system may contain one or more interfaces (e.g., network communication device 920) that connect computer system to a communication network 908 (in addition or as an alternative to the network 910).

The storage system, typically includes a computer readable and writeable nonvolatile recording medium in which signals are stored that define a program to be executed by the processor or information stored on or in the medium to be processed by the program. The medium may, for example, be a disk or flash memory. Typically, in operation, the processor 916 causes data to be read from the nonvolatile recording medium into another memory that allows for faster access to the information by the processor than does the medium. This memory is typically a volatile, random access memory such as a dynamic random access memory (DRAM) or static memory (SRAM). The memory may be located in storage system 918, as shown, or in memory system 914. The processor 916 generally manipulates the data within the memory 914, and then copies the data to the medium associated with storage after processing is completed. A variety of mechanisms are known for managing data movement between the medium and integrated circuit memory and the invention is not limited thereto. The invention is not limited to a particular memory system 914 or storage system 916.

The computer system may include specially-programmed, special-purpose hardware, for example, an application-specific integrated circuit (ASIC). Aspects of the invention may be implemented in software, hardware or firmware, or any combination thereof. Further, such methods, acts, systems, system elements and components thereof may be implemented as part of the computer system described above or as an independent component.

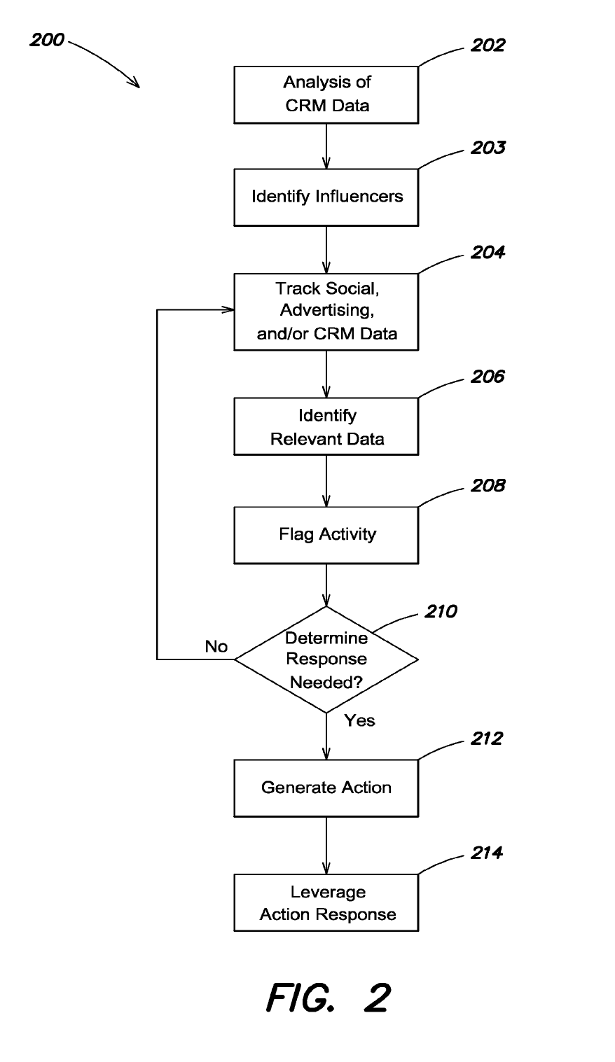

Although the computer system of FIG. 9 is shown by way of example as one type of computer system upon which various aspects of the invention may be practiced, it should be appreciated that aspects of the invention are not limited to being implemented on the computer system as shown. Various aspects of the invention may be practiced on one or more computers having a different architectures or components that that shown in FIG. 9. The system can execute the processes illustrated for example FIGS. 2-8, and/or components of a system (e.g. system 100) can be configured to execute the processes illustrated in FIGS. 2-8. The process can include also other processes, sub-processes, and may execute multiple processes in conjunction, for example, as illustrated in FIGS. 2-8.

The computer system may be a general-purpose computer system that is programmable using a high-level computer programming language. The computer system may be also implemented using specially programmed, special purpose hardware. In the computer system, processor is typically a commercially available processor such as the well-known Pentium class processor available from the Intel Corporation. Many other processors are available including multi-core processors and microprocessors. Such a processor usually executes an operating system which may be, for example, the Windows-based operating systems (e.g., Windows NT, Windows 2000 (Windows ME), Windows XP, Windows VISTA, Windows 7 and 8 operating systems) available from the Microsoft Corporation, MAC OS System X operating system available from Apple Computer, one or more of the Linux-based operating system distributions (e.g., the Enterprise Linux operating system available from Red Hat Inc.), the Solaris operating system available from Sun Microsystems, or UNIX operating systems available from various sources. Many other operating systems may be used, and the invention is not limited to any particular operating system.

The processor and operating system together define a computer platform for which application programs in high-level programming languages are written. It should be understood that the invention is not limited to a particular computer system platform, processor, operating system, or network. Also, it should be apparent to those skilled in the art that the present invention is not limited to a specific programming language or computer system. Further, it should be appreciated that other appropriate programming languages and other appropriate computer systems could also be used.

One or more portions of the computer system may be distributed across one or more computer systems coupled to a communications network. These computer systems also may be general-purpose computer systems. For example, various aspects of the invention may be distributed among one or more computer systems (e.g., servers) configured to provide a service to one or more client computers, or to perform an overall task as part of a distributed system. For example, various aspects of the invention may be performed on a client-server or multi-tier system that includes components distributed among one or more server systems that perform various functions according to various embodiments of the invention including displaying, defining, accessing, and evaluating an entity's social network, as examples. Other components can be configured to execute actions, execute CRM actions, poll electronic resources for social graph data, poll social sites, poll aggregation sites, etc. These components may be executable, intermediate (e.g., IL) or interpreted (e.g., Java) code which communicate over a communication network (e.g., the Internet) using a communication protocol (e.g., TCP/IP).

It should be appreciated that the invention is not limited to executing on any particular system or group of systems. Also, it should be appreciated that the invention is not limited to any particular distributed architecture, network, or communication protocol.

Various embodiments of the present invention may be programmed using an object-oriented programming language, such as Java, C++, Ada, or C# (C-Sharp). Other object-oriented programming languages may also be used. Alternatively, functional, scripting, and/or logical programming languages may be used. Various aspects of the invention may be implemented in a non-programmed environment (e.g., documents created in HTML, XML or other format that, when viewed in a window of a browser program, render aspects of a graphical-user interface (GUI) or perform other functions). Various aspects of the invention may be implemented as programmed or non-programmed elements, or any combination thereof.

Various aspects of this system can be implemented by one or more systems within the computer system. For instance, the system may be a distributed system (e.g., client server, multi-tier system). In one example, the system includes software processes executing on a system associated with a user (e.g., a client system). These systems may permit the user to register, input demographic information, input profile information, identify social networking sites, identify other online sources of information, receive information from a social graph management system, receive offers from a social graph management system, etc. Further, client systems can be associated with registered users who access, for example, a social site maintained by an entity.

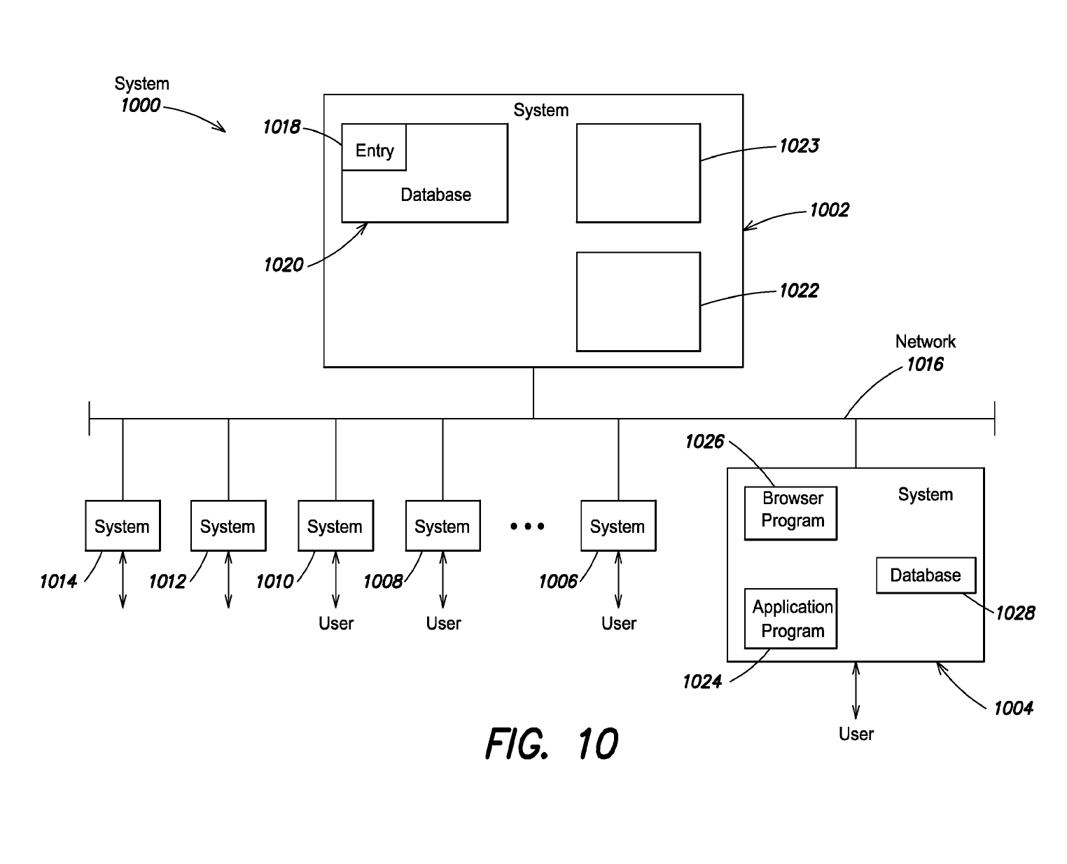

FIG. 10 shows an architecture diagram of an example system according to one embodiment of the invention. It should be appreciated that FIG. 10 is used for illustration purposes only, and that other architectures may be used to facilitate one or more aspects of the present invention.

As shown in FIG. 10, a distributed system 1000 of composed of a plurality of general purpose computer system (e.g., 102-1014) specially configured to conduct functions of the system for managing a social graph, including, but limited to, generation, monitoring, and evaluation of data within a social graph for an entity, population segmentation, etc. The distributed system may include one or more general purpose computer systems (e.g., 1002-1014) coupled by a communication network 1016. Such computer systems may be, for example, general-purpose computer systems as discussed above with reference to FIG. 9.

In one embodiment of the present invention, a system 1002 stores attributes associated with customer populations, collects information on connections to an entity within the entity's social graph, and collects any user input information. Each customer population can be associated with an entry 1018 in the database 1020, and each population associated with specific actions, activities, etc. Although other database models can be used to store information. In some examples, a relational database model is implemented, and in others, non-relational database models can be employed.

Further, the system performs associated functions with the displaying, classifying and retaining, and engaging customer populations. The system 1002 can also be configured to provide access to information associated with an entity's social graph and display any information through a user interface accessible over a communication network 1016, for example, the Internet.

The system may include a server process 1022 and/or program 1023 that responds to requests from one or more client programs. Process 1022 may include, for example, an HTTP server or other server-based process (e.g., a database server process, XML server, peer-to-peer process) that interfaces to one or more client programs distributed among one or more client systems, for example, to provide access to information on connections of a given entity and any connections to those connections.

According to one embodiment, client programs 1024 may be capable of permitting a user to create, submit, alter, monitor, and comment on products and/or services of an entity. Such client programs may include, for example, any type of operating system and/or application program capable of communicating with the system through a network. In one particular instance, a client may include a browser program (e.g., browser program 1026) that communicates with a server process 1022 using one or more communication protocols (e.g., HTTP over a TCP/IP-based network, XML requests using HTTP through an Ajax client process, distributed objects, https, or other secure or non-secure communication protocol).

Although it is shown by way of example that a browser program 1026 may be used to access the social graph management system by users to perform functions for managing an entity's social graph, it should be appreciated that other program types may be used. The client program may be, for example, a thin client including an interface for submitting and monitoring a social graph, or an automated process for capturing social data, aggregation, and/or CRM data. Alternatively, the client may be a scripted program, or any other type of program having the capability of transferring data from, for example, a database 1028. According to one embodiment, such client programs may, for example, be downloaded and installed over the network. Further, these client programs may be stored and distributed by system in the form of one or more software programs, including for example, browser plug-ins, active x objects, applets, and java code.

Having thus described several aspects of at least one embodiment, it is to be appreciated various alterations, modifications, and improvements will readily occur to those skilled in the art. Such alterations, modifications, and improvements are intended to be part of this disclosure and are intended to be within the scope of the invention. Accordingly, the foregoing description and drawings are by way of example only.

1. A system for managing an entity's social graph, the system comprising:
at least one processor operatively connected to a memory, the processor configured to execute a plurality of system components, the plurality of system components comprising:
an integration component configured to:
accept customer data from a plurality of data sources, the data sources including at least one of: at least one CRM platform and at least one aggregation platform;
accept social media information from at least one social platform;
a segmentation engine configured to segment a customer population into a plurality of segments, based, at least in part on the customer data and social media information;
an insight engine configured to generate an insight for at least one of the plurality of segments; and
a generation engine configured to generate an action responsive to the insight.

2. The system according to claim 1, wherein the generation engine is further configured to communicate the action to the at least one CRM platform, wherein the action is configured to cause the CRM system to deliver an offer to a customer based on the action.

3. The system according to claim 2, further comprising a tracking component configured to track redemption of the offer, wherein tracking the redemption of the offer includes at least one of:
monitoring social media sites associated with the customer;
capturing posts associated with the entity or the entity's products or services; and
monitoring sites associated with the customer and sites associated with the customer's connections.

4-6. (canceled)

7. The system according to claim 3, wherein the insight engine is configured to identify a target group to receive a notification regarding conversion of the offer to influenced connections of the customer.

8. The system according to claim 3, wherein the generation engine is configured to generate the action such that the customer is required to publish a notification regarding the entity.

9. The system according to claim 3, wherein the tracking component is configured to parse social postings to identify postings associated with the customer or a customer connection and the entity, entity's products, or entity's services.

10. The system according to claim 1, wherein the insight component is configured to define customer activity scenarios associated with the actions.

11. The system according to claim 10, wherein the insight component is configured to determine that at least one customer activity scenario has been performed.

12. The system according to claim 10, wherein the insight component is configured to define a number of actions required to include in the customer activity scenario, based on data obtained from at least one of the at least one CRM platform and the at least one aggregation platform, and the at least one social platform.

13. The system according to claim 10, wherein the system is configured to detect customer activity matching the defined scenario and communicate a trigger to the generation engine identify the matching scenario and any associated insight.

14. The system according to claim 13, wherein the insight component is configured to modify the customer activity scenario responsive to customers' redemptions associated with the action.

15. The system according to claim 13, wherein the generation engine is configured to generate the action responsive to the matching scenario.

16. The system according to claim 15, wherein the generation engine is configured to tailor the action based on the customer activity scenario and on context associated with the customer activity scenario.

17. (canceled)

18. The system according to claim 15, wherein the generation engine is configured to tailor the action based on a customer segment associated with the customer.

19. The system according to claim 2, further comprising a publication component configured to publish an acceptance of the offer, wherein the publication component is configured to target publication of the acceptance of the offer to a segment associated with the customer.

20. (canceled)

21. A computer implemented method for managing an entity's social graph, the method comprising:
accessing, by a computer system, customer data from at least one of: at least one CRM platform and at least one aggregation platform;
accessing, by the computer system, social media information from at least one social platform;
segmenting, by the computer system, a customer population into a plurality of segments, based, at least in part on the customer data and social media information;
generating, by the computer system, an insight for at least one member of the customer population within at least one of the plurality of segments, responsive to activity identified in the social media information and customer data; and
generating, by the computer system, an action responsive to the insight.

22-27. (canceled)

28. The method according to claim 21, wherein generating the action includes generating the action such that the customer is required to publish a notification regarding the entity.

29. The method according to claim 21, further comprising parsing social media to identify postings associated with the customer or a customer connection and the entity, entity's products, or entity's services.

30. The method according to claim 21, further comprising defining customer activity scenarios associated with the actions.

31. The method according to claim 30, further comprising determining that at least one customer activity scenario has been performed.

32. The method according to claim 30, further comprising defining a number of actions required to include in the customer activity scenario, based on data obtained from the at least one of the at least one CRM platform and the at least one aggregation platform, and the at least one social platform.

33. The method according to claim 30, further comprising detecting customer activity matching the defined scenario and communicate a trigger to the generation engine identify the matching scenario and any associated insight.

34. The method according to claim 33, further comprising modifying the customer activity scenario responsive to customers redemptions associated with the action.

35-40. (canceled)
